(19) United States
(12) Patent Application Publication
(10) Pub. No.: US 2018/0023708 A1
(43) Pub. Date: Jan. 25, 2018

(54) SEAL ASSEMBLY AND METHOD FOR MANUFACTURING THE SEAL ASSEMBLY

(71) Applicant: Aktiebolaget SKF, Goteborg (SE)

(72) Inventors: Erich Pfandl, Zeltweg (AT); Johann Moitzi, Eppenstein (AT)

(21) Appl. No.: 15/651,031

(22) Filed: Jul. 17, 2017

(30) Foreign Application Priority Data
Jul. 25, 2016 (DE) 102016213613.5

(51) Int. Cl. F16J 15/3272; F16J 15/34

(52) U.S. Cl. CPC F16J 15/3272; F16J 15/3488; F16J 15/3456; F16J 15/3496

(57) ABSTRACT

A seal assembly includes a base body having a seal element and a retainer radially spaced from the seal element. The retainer includes a support surface facing the seal element, and a support ring abuts on the support surface of the retainer. The support ring has a first end and a second end circumferentially spaced from the first end, and a portion of the first end extends into a recess of the second end to connect the first end to the second end. Also a method of manufacturing the seal assembly.

### CROSS-REFERENCE

This application claims priority to German patent application no. 10 2016 213 613.5 filed on Jul. 25, 2016, the contents of which are fully incorporated herein by reference.

### TECHNOLOGICAL FIELD

The disclosure relates to a seal assembly as well as a method for manufacturing the seal assembly.

Seal assemblies are known in various embodiments and are used, for example, for sealing an interior filled with liquid in a transmission or engine of a motor vehicle, but also in numerous comparable situations. Here a rotating shaft is often used for force transmission, which shaft extends from the interior into the environment. For sealing purposes, known seal assemblies, for example, radial shaft seal rings, usually include a round retaining ring, for example, made from steel, to which a seal element is attached by vulcanization. The retaining ring is placed in a corresponding seat on the housing in a friction-fit manner such that a seal lip of the seal element surrounds the shaft and thus seals the interior with respect to the environment. In order to ensure a friction fit, the support ring can also be surrounded at the radially outer-lying end by a plastic.

The seal elements often include an annular groove on a radially outer portion for receiving a spring. The contact pressure of the seal lip on the shaft is thereby increased by the spring generating a torque on the seal lip. However, there are also embodiments known wherein no spring is used. Seal elements of known radial shaft seal rings are typically comprised of polytetrafluoroethylene (PTFE) or an elastomer material.

Such seal assemblies are often articles that are manufactured in mass production and sold in correspondingly large quantities. In this respect comparatively complex production steps, such as vulcanizing or injection molding in corresponding molds, can also be used here, and the support rings can be produced in the required amount.

In addition, seal assemblies are known in which a retaining ring and a seal element are manufactured one-piece by machining from a plastic-ring or -tube. A precise producing of the seal assembly according to required dimensions of a prescribed installation situation is advantageous here. Here, above all in the case of radial shaft seal rings, the outer diameter is adaptable for the housing seat, as well as the inner diameter of the seal lip. The material of the plastic ring must be sufficiently soft to ensure a sufficient sealing effect of the seal lip on the shaft. Such seal assemblies are used, for example, in the case of small quantities, including for the replacement of defective seals. These can be single-unit productions.

For stabilizing the retaining ring, another steel ring is often used in such seal assemblies, since the plastic does not have the necessary stability for securely retaining the seal assembly in the housing seat. However, the disadvantage thereby arises that due to the large number of possible dimensions, matching steel rings must be kept available in a wide variety of dimensions or be manufactured individually corresponding to the dimensions, which greatly complicates either warehousing or manufacturing.

Alternatively a stabilizing ring made from a stiffer plastic than that of the seal element and support ring can be used for stabilizing the retaining ring. Here polyoxymethylene (POM) or polyamide (PA) are typically used. In comparison to the use of steel rings it is advantageous that such stabilizing rings made from plastic can also be manufactured by machining from a blank. It is disadvantageous here that due to the different thermal expansion coefficients of the two plastics, the stabilizing ring expands or contracts during heating and cooling to a greater degree than the retaining ring. Loss of the stabilizing effect can thereby occur, with the result that the seal assembly is no longer securely held in the housing seat. It can then rotate together with the shaft or fall out of the housing. Consequently such seal assemblies are not as universally usable as seal assemblies having a supporting steel ring.

### SUMMARY

It is an aspect of the present disclosure to provide a seal assembly that can be used in many ways, wherein the disadvantages mentioned above are avoided. It is a further aspect of the disclosure to provide a method for manufacturing the seal assembly.

A seal assembly according to the present disclosure comprises the following features:
a base body,
the base body includes a seal element,
the base body includes a retaining element opposite the seal element and connected to the seal element; the retaining element includes a support surface facing the seal element,
a support element abutting on the support surface, and
the support element is manufactured from a base support element that includes two ends that are fixed at such a distance to each other that the support element thus formed is adapted to a dimension of the support surface.

Such a seal assembly can be manufactured in a simple manner adapted to the respective installation situation. Support elements adapted to the respectively required support surface can be produced from the base support element by corresponding fixing of the ends, so that only a small number, in the simplest case even only one type of base support element must be provided in order to be able to manufacture a large number of seal assemblies of different dimensions. This is particularly advantageous with the production of small quantities that are generated by machining of a blank, since the above-described disadvantages are thus avoided.

In the case of a round seal assembly, the support surface preferably also has a round contour having a diameter and preferably lies radially inwardly on the retaining element. The support element has a corresponding radially outwardly lying round contour. A supporting effect can thus be achieved along the circumference of the support surface in a simple manner.

In one advantageous embodiment of the disclosure the base support element includes at least two connecting units corresponding to each other, using which the two ends of the base support element are fixable to each other at different distances. A particularly simple possibility is thereby provided to adapt the dimension of the support element to the dimension of the support surface. By fixing the two ends relative to each other, the support element is formed from the base support element such that the support element is adapted to the dimension of the support element. The support element thus formed has the necessary stability to stabilize the retaining element.

In one advantageous embodiment of the disclosure one of the connecting units is embodied as a fixing element. The other of the connecting units includes a plurality of engaging elements that are configured such that the ends are fixable at various distances to each other by bringing the fixing element into engagement with at least one of the engaging elements. Due to this design an easy-to-handle arrangement is provided for fixing the ends at different distances to each other, with the result that an adapted support element can be particularly simply manufactured.

In one advantageous embodiment of the disclosure the seal assembly further has the following features:
the fixing element includes at least one projection associated with the first end of the base support element,
the engaging elements are formed by the recesses associated with the second end of the base support element, which recesses are bringable into engagement with the at least one projection.

A base support element designed in this manner is particularly simple to manufacture and makes possible the manufacturing in a simple manner of the support element with adapted dimension. By selectively bringing the projection into engagement with one of the recesses the dimension adapted to the support surface is easily adjustable. A readjusting by releasing the engagement and renewed bringing into engagement with a different recess is also possible, with the result that errors in the manufacturing are easily remedied.

Here exactly one end projection can be associated with the first end, which projection is bringable into engagement with exactly one of the recesses. This embodiment is particularly simple to manufacture. Alternatively also two or more projections can be associated with the first end, which projections are then brought into engagement with a corresponding number of recesses. An improved, in particular a more stable fixing of the two ends is thereby achieved. Here in one possible embodiment the projections are spaced in a manner analogous to the recesses.

Alternatively the projections can also have larger spacings than the recesses, wherein then, for example, the spacing is selected such that a first of the projections is brought into engagement into a first of the recesses and a second of the projections into a second of the recesses. At least one recess that is not in engagement with a projection then lies between the two recesses. The fixing can thereby be further improved.

Also in an alternative embodiment of the disclosure, wherein as described a plurality of projections are provided on the base support element, the projections are removable in a simple manner in order to form the fixing of the two ends corresponding to the requirements. For this purpose the projections have, for example, a predetermined break point. Thus with the removal of all projections down to one, for example, a relatively compact support element can be generated wherein the stiffness of the fixing is of less importance. Larger support elements can then also be generated from the same base support element by using a plurality of projections, which then have an increased stiffness of the fixing.

In one advantageous embodiment of the disclosure the recesses are spaced such that by selective bringing into engagement of the at least one projection with a number of the recesses corresponding to the number of projections an essentially round support element is manufacturable having a circumference adapted to the dimension. Here support elements of various circumferences can be manufactured in a simple manner from the same type of support element by selecting the appropriate recesses, which support element is then adapted to the circumference of the support surface.

In one advantageous embodiment of the disclosure the at least one projection is formed as at least one tab and the recesses as holes. In this manner the projection and the recess can be particularly simple to manufacture and are simple to bring into engagement with each other. In this embodiment there is a size difference between the dimensions of the generatable support elements, which size difference is established by the distance of the holes to one another. If the distance between two holes, for example, is approximately 3.14 mm, i.e., approximately π mm, then the difference in diameter of two support elements generated by holes, selected adjacent, brought into engagement with the tab is approximately 1 mm. Thus by choosing the next respective hole the diameter of the support element generated can respectively be increased by 1 mm. Accordingly the dimension of the support surface is then to be generated with the machining.

In one advantageous embodiment of the disclosure the base support element comprises a flat metallic band. Metallic support elements have advantageous properties with respect to stability and thermal expansion. In addition, they are simple to manufacture and can easily be processed into adapted support elements.

In one advantageous embodiment of the disclosure the metallic band is made from spring steel, which has particularly good properties with respect to stability and manufacturability. A metal plate is preferably considered here.

In one alternative embodiment of the disclosure, the fixing element comprises a rotatable screw element. The engaging elements are formed by openings, perforations, or embossments, wherein the screw element is bringable into engagement with at least one of the openings, perforations, or embossments. Due to the rotatability of the screw element a nearly stepless enlarging and shrinking of the base support element is made possible for adapting to the dimension of the support surface.

In one preferred embodiment of the disclosure the screw element is held in a housing which housing includes a tunnel opening through which the end of the base support element including the openings, perforations, or embossments is guidable. The tunnel opening is disposed in the housing such that with guiding of the end through the tunnel opening the screw element is in engagement with the openings, perforations, or embossments. In this manner a simple mechanism can be provided that makes possible nearly stepless enlarging and shrinking of the base support element for adapting it to the dimension of the support surface.

In one alternative embodiment of the disclosure two ends of the base support element each have a holding unit. The two holding units are connected by a connecting element, wherein the holding units and the connecting element are designed such that a spacing of the two ends is variable.

In one preferred embodiment of the disclosure the holding elements are embodied as pins that each include a receptacle for a screw. The connecting element is embodied as a screw, using which the ends are fixable at a defined distance to each other. By rotating the screw the distance can be varied so that a support element adapted to the dimension of the support surface is generatable.

In another embodiment, the disclosure comprises a seal assembly that has a base body including a seal element and a retainer radially spaced from the seal element, the retainer including a support surface facing the seal element. The assembly also includes a support ring abutting on the support surface of the retainer. The support ring has a first end and a second end circumferentially spaced from the first end, and a portion of the first end extends into a recess of the second end to connect the first end to the second end.

Still another aspect of the disclosure comprises a method for manufacturing a seal assembly that includes manufacturing a base body including a seal element and a retainer radially spaced from the seal element, the retainer including a support surface facing the seal element. The method also includes providing an adjustable diameter support ring, adjusting the diameter of support ring to correspond to a diameter of the retainer, and installing the adjusted support ring in the retainer.

A method for manufacturing a seal assembly is a further aspect of the disclosure, and includes the following method steps:
manufacturing of a base body including a seal element and a retaining element having dimensions adapted to a given installation situation,
generating of a support surface of a dimension defined such that the manufacturing of a support element from a provided base support element is made possible,
manufacturing of a support element from the base support element by adapting of the dimension to the support surface,
abutting of the support element on the support surface of the base body.

This simple-to-perform method is characterized in particular by a high flexibility. Thus even small series or even individual seal assemblies can be manufactured cost-effectively. With few manufacturing steps a stable seal assembly can be manufactured that is stabilized by an individually adapted support element. A loss of stability, for example, due to thermal effects, can thus be effectively prevented.

With the generating of the support surface corresponding to the support element, care is taken to define the corresponding dimension such that a suitable support element can be manufactured from the provided base support element. This is necessary in particular with the use of base support elements whose dimensions cannot be changed in a stepless manner. In particular in the described embodiments of the disclosure wherein a tab is brought into engagement with holes, there is a size difference between the generatable dimensions of the support elements, which size difference is established by the distance of the holes to each other. If the distance between two holes is, for example, approximately 3.14 mm, i.e., approximately π mm, then the difference in diameter of two support elements generated by holes, selected adjacent, brought into engagement with the tab is approximately 1 mm. Thus by choosing the next respective hole the diameter of the support element generated can respectively be increased by 1 mm. Accordingly the dimension of the support surface is then to be generated with the machining.

### BRIEF DESCRIPTION OF THE DRAWINGS

Further advantages, features, and details of the disclosure result from the exemplary embodiments of the disclosure described below with reference to the Figures.

FIG. 1 shows an embodiment of the disclosure.

FIG. 2 shows a base support element according to the embodiment of the disclosure.

FIG. 3 shows a detail view of a support element according to the embodiment of the disclosure.

FIG. 4 shows an alternative embodiment of a closure mechanism of a support element according to an embodiment of the disclosure.

FIG. 5 shows an alternative embodiment of a support element according to an embodiment of the disclosure.

FIG. 6 shows a further alternative embodiment of a support element according to an embodiment of the disclosure.

FIG. 7 shows a schematic depiction of a manufacturing method for the embodiment of FIGS. 1 to 6.

### DETAILED DESCRIPTION

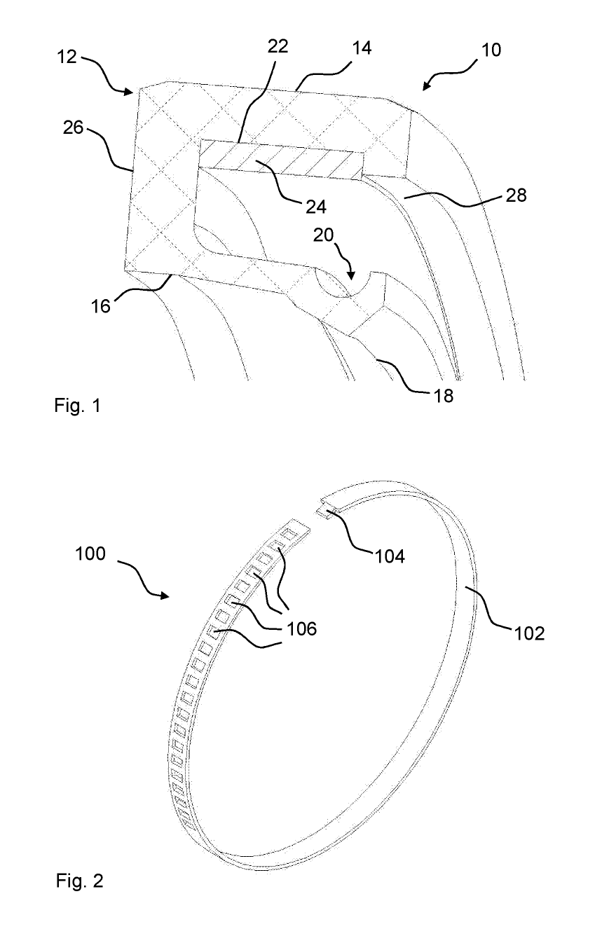

FIG. 1 shows, as a preferred embodiment of the disclosure, a radial shaft seal ring 10 in a sectional view. The radial shaft seal ring 10 comprises a base body 12 made from a plastic, which base body 12 includes a plurality of partial regions. In the radially outer region of the base body 12 a retaining element 14 is formed that is, for example, inserted in a housing seat in a not-depicted installation situation. In a radially inner region, the base body 12 comprises a seal element 16 including a seal lip 18 formed on an arm-like extension, which seal lip 18 in the installed state abuts on a not-depicted shaft. Opposite the seal lip 18 a groove 20 is provided into which a spring (not depicted here) is insertable. The spring induces a torque defined by the choice of the spring constant on the arm-like extension, with the result that a contact force of the seal lip 18 on the shaft is generated. The seal effect of the seal lip 18 is thereby ensured.

The radially inner lying side of the retaining element 14 includes a support surface 22 on which a support ring 24 is inserted. The support ring 24 is comprised of a material of higher strength than the base body, for example, of a metal such as steel or aluminum. Spring steel is preferably used. Its outer diameter is adapted to the diameter of the support surface 22. The support ring 24 stabilizes the retaining element 14. Due to its use a torque exerted on the retaining element 14 cannot lead to a bending or deforming of the same, with the result that in the installed state the retaining element is securely held in the housing seat.

The retaining element 14 is connected on an axial end to the seal element 16 by a connecting element 26. On the axially opposing end the retaining element 14 has a shaping 28 that is directed radially inward and partially comprises the support element 24. The support element 24 is thereby prevented from slipping axially.

The retaining element 14, the seal element 16, and the connecting element 26 are preferably formed one-piece in the base body 12 and manufactured from a plastic blank, for example, in the shape of a cylinder or ring by machining. Here a blank of suitable dimensions is selected and, for example, processed in a lathe. Thus the retaining element 14, the seal element 16, and the connecting element 26, as well as the seal lip 18, the groove 20, the support surface 22, and the shaping 28 are developed by ablation of material. The dimensioning of these elements occurs corresponding to the planned installation situation of the radial shaft seal ring 10. The inner diameter of the support surface 22 is generated such that a support element 24 adapted to this inner diameter can be produced from a base support element, which is described based on the following Figures.

FIG. 2 shows a base support element 100 that is comprised of a flat metal band 102 made from a spring steel. The metal band 102 includes on one side a tab 104 that is slightly bent radially inward. On the opposite end of the metal band 102 numerous recesses 106 in the form of holes are introduced that are preferably disposed equidistant. The dimensions of the recesses 106 are chosen such that the tab 104 is introducible from outside into one of the recesses 106. Due to this connection an essentially circular stable ring can be generated that is then inserted as the support element 24 into the retaining element 14. The axial dimension of the support surface 22 is generated according to the width of the support element 24.

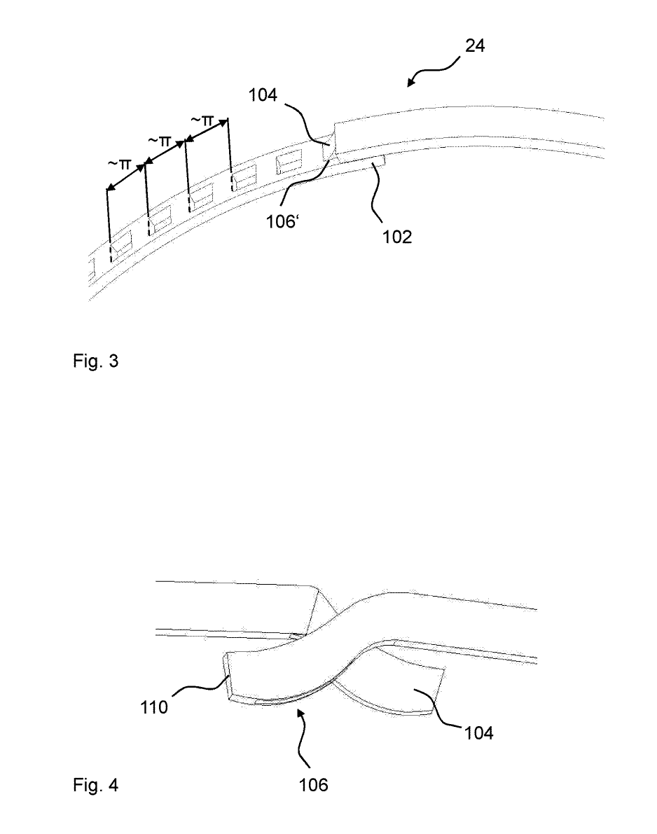

In the embodiment described herein the spacing of the recesses 106 on the metal band 102 is approximately 3.14 mm, which corresponds to approximately π mm. This is depicted in the detail view of FIG. 3. Thus by introducing the tab 104 into one of the recesses 106, different support elements 24 having different diameters and circumferences can be manufactured from identical base support elements. Here a support element 24 having a minimum circumference U₀ is manufactured by selection of the recess lying farthest from the end of the metal band 102. The possible circumferences of the further manufacturable support elements 24 are given by the formula:

Uₙ=U₀+n·π,

$${d}_{n} = \frac{{U}_{n}}{π}$$

wherein n is a natural number. The diameter or me support element 24 is given by transformation to:

$${d}_{n} = \frac{{U}_{0}}{π} + n mm .$$

Consequently due to the spacing thus defined of the recesses 106 by selection of the respective adjacent recess 106, the diameter of the finished support element 24 can increase by approximately 1 mm. For establishing other increases of the diameter by selection of adjacent recesses 106, in other embodiments of the disclosure they can be formed at different spacings on the metal band.

In FIG. 3 a finished support element 24 is also depicted sectionally. The tab 104 is introduced into one of the recesses 106′, whereby the ends of the base support element 100 are connected. A possibly still protruding end of the metal bland 102 can be cut to length after introducing of the tab 104 into the recess 106. Among other things the weight of the finished radial shaft seal ring 10 is thereby reduced.

In FIG. 4 an improved manner of connecting tab 104 and recess 106 is depicted. Like the tab 104, the end 110 of the metal band 100, which end 110 includes the recess 106 and is possibly already cut to length, is bent radially inward. The offset of the two ends, which offset arises radially outwardly, visible in FIG. 3, is thereby reduced, with the result that the support element 24 is better abuttable on the support surface 22. The radially inward portion of the support element 24 does not abut on the base body 12, with the result that the tab 104 and the end 110 do not influence the functionality of the radial shaft seal ring 10.

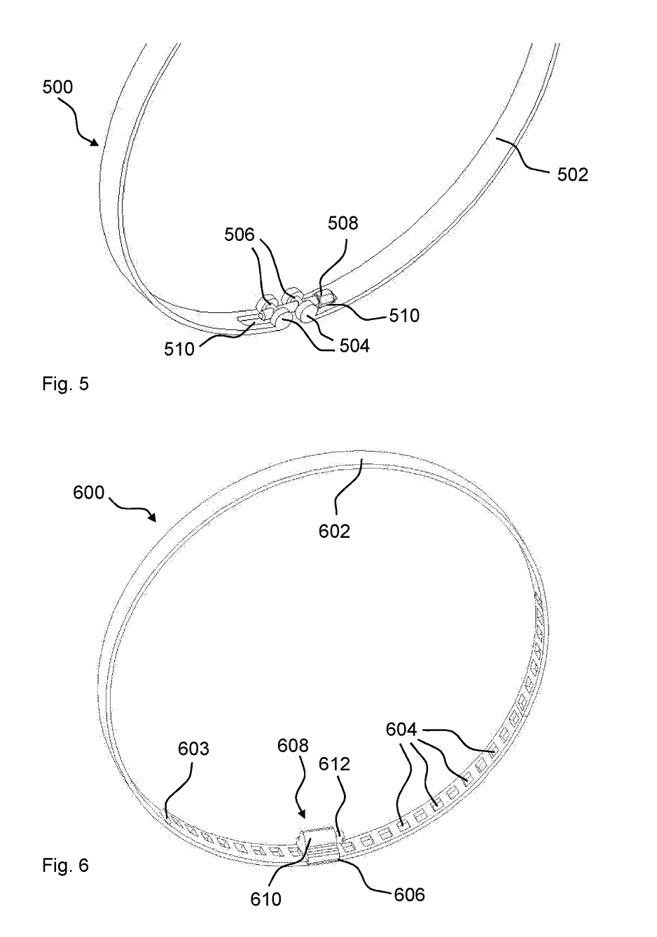

In FIG. 5 an alternative embodiment of a base support element 500 in the form of a metal band 502 is shown. It is designed similar to the metal band depicted in FIG. 2; however, it has a different mechanism to vary the diameter or the circumference. A receptacle 504 is formed on each of the two ends of the metal band 502, into each of which a pin 506 is inserted. The two pins 606 have a thread in their center into which a screw 508 is inserted. These connect the two pins 506. For free mobility and accessibility of the screw 508, the metal band 502 respectively has a slot 510 on both ends. By rotating the screw, the pin 506 and thus the ends of the metal band 502 can move toward each other or away from each other. The diameter of the base support element 500 can thereby vary and generate a support element 24 adapted to the support surface 22. The maximum change in the diameter or circumference of the base support element 500 is established by the length of the screw 508.

In FIG. 6 a further alternative embodiment of a base support element 600 in the form of a metal band 602 is depicted. Similar to the embodiment depicted in FIG. 2, the metal band 602 includes numerous recesses 604 in the form of holes emanating from one end. These can alternatively also be embodied as embossments or perforations. On the other end 606 an adjusting element 608 is attached that comprises a housing 610. A screw element 612 is rotatably held in the housing 610. Between the screw element 612 and end 606 of the metal band 602 a tunnel opening 610 is provided through which the end 603 of the metal band 602 can be guided. The screw element 612 then engages into the recesses 604 such that by rotating the screw element 612, the end 603 can be moved against the end 606. Thus support elements of different diameters or circumferences for the radial shaft seal ring 10 can also be generated in this exemplary embodiment of the disclosure. Here it is even possible to vary the circumference in a nearly stepless manner and also in the already-installed state.

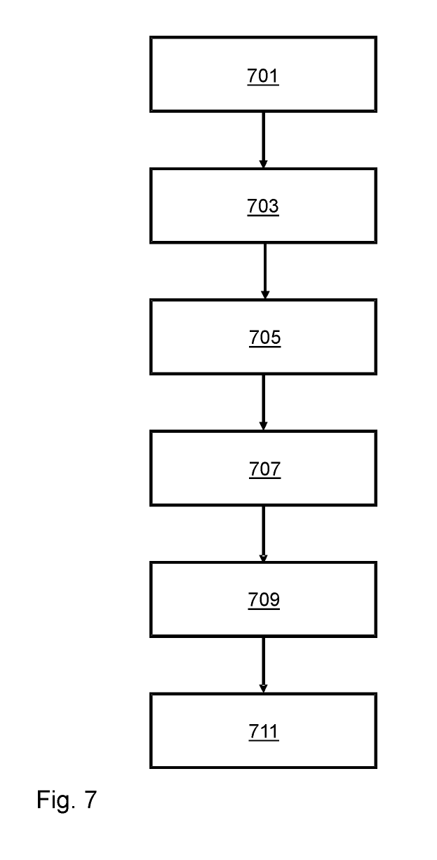

The embodiments depicted in FIGS. 1 to 6 can be, for example, manufactured according to the method described in the following and schematically depicted in FIG. 7. Here the manufacturing of the embodiment depicted in FIGS. 1 to 4 is described in an exemplary manner. First in a method step 701 the outer contour of the base body 12 including the retaining element 14, the seal element 14 including the seal lip 18, and the connecting element 26 is manufactured. The base body 12 is generated by machining a cylindrical blank made from plastic. The outer diameter of the retaining element 14 and the inner diameter of the seal lip, as well as the angle of the arm-like extension of the seal element 14, are manufactured in a manner adapted according to the given installation situation.

In a second method step 703, the inner contour of the base body 12 including the shaping 28, the groove 20, and the support surface 22 is generated by machining. The inner diameter and the axial width of the support surface 22 are selected such that in the following method step 705 a suitable support element 24 can be manufactured from a base support element 100. In this third method step 705 a base support element 100 is provided and the tab 104 is introduced into one of the recesses 106. Here the recess 106′ is selected wherein the outer diameter of the thus formed support element 24 corresponds to the inner diameter of the support surface 22.

In a fourth method step 707 the end of the metal band 102 projecting over the tab 104 is cut to length, with the result that a new end arises near the recess 106′ brought into engagement with the tab 104. In a fifth method step 709 the newly generated end of the metal band 102 is deformed radially inward in the region of the recess 106′ in engagement with the tab 104 such that a course nearly symmetric to but opposite to the obliquely inwardly directed tab 104. A nearly stepless outer diameter of the support element 24 thereby arises that can thus abut on the support surface 22 almost completely along its circumference.

In a sixth method step 711 the generated support element 24 is inserted in the base body 12 so that it abuts on the support surface between the connecting element 26 and the shaping 28. A spring of suitable length is subsequently inserted into the groove 20.

The depicted embodiments of the disclosure can be transferred in a simple manner to other seal types so that these also benefit from the simplified and more flexible manufacturing method and the flexible usability. Exemplary embodiments according to the disclosure also increase the range of use of seals manufactured by machining, with the result that replacement parts and small production runs are also cost-effectively manufacturable even individually.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved seal assemblies.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

10 Radial shaft seal ring
12 Base body
14 Retaining element
16 Seal element
18 Seal lip
20 Groove
22 Support surface
24 Support element
26 Connecting element
28 Shaping
100 Base support element
102 Metal band
104 Tab
106, 106′ Recess
500 Base support element
502 Metal band
504 Receptacle
506 Pin
508 Screw
510 Slot
600 Base support element
602 Metal band
603 End
604 Opening
606 End
608 Adjusting element
610 Housing
612 Screw element

1. A seal assembly, comprising:
a base body including a seal element and a retainer radially spaced from the seal element, the retainer including a support surface facing the seal element, and
a support ring abutting on the support surface of the retainer,
wherein the support ring has a first end and a second end circumferentially spaced from the first end, and
wherein a portion of the first end extends into a recess of the second end to connect the first end to the second end.

2. The seal assembly according to claim 1, wherein the first end of the support ring includes at least one first connector and the second end of the support ring includes at least one second connector complementary to the first connector, the at least one first connector being connectable to the at least one second connector to form the support ring having a first diameter and to form the support ring having a second diameter greater than the first diameter.

3. The seal assembly according to claim 2, wherein the at least one first connector is a fixing element and at least one second connector is a plurality of engaging elements configured such that the first end is fixable to the second end at various distances to each other by bringing the fixing element into engagement with at least one of the engaging elements.

4. The seal assembly according to claim 1,
wherein the first end of the support ring includes at least one projection and the second end of the support ring includes at least one recess configured to receive the at least one projection.

5. The seal assembly according to claim 4, wherein the at least one recesses comprises a plurality of recesses.

6. The seal assembly according to claim 4, wherein the at least one projection is formed as at least one tab and the plurality of recesses are holes.

7. The seal assembly according to claim 1, wherein the support ring comprises a flat metal band.

8. The seal assembly according to claim 7, wherein the metal band is formed from spring steel.

9. The seal assembly according to claim 1, wherein the base body is substantially C-shaped in radial section and has an open interior, wherein the seal is a radially inwardly directed lip and wherein the support surface comprises a cylindrical surface in the interior.

10. The seal assembly according to claim 1, wherein the support ring comprises a cylindrical metal band.

11. The seal assembly according to claim 10, wherein the cylindrical metal band includes a plurality of through openings extending from a radially outer side of the band to a radially inner side of the band and wherein the first end includes a tab receivable any one of a plurality of the through openings to connect the first end of the band to the second end of the band.

12. The seal assembly according to claim 10, wherein a portion of the first end of the band radially overlaps a portion of the second end of the band.

13. A method for manufacturing a seal assembly comprising:
manufacturing a base body including a seal element and a retainer radially spaced from the seal element, the retainer including a support surface facing the seal element;
providing an adjustable diameter support ring;
adjusting the diameter of support ring to correspond to a diameter of the retainer; and
installing the adjusted support ring in the retainer.

14. The method according to claim 13, wherein the support ring includes a first end and a second end spaced circumferentially from the first end and a plurality of recesses in the support ring between the first end and the second end and wherein adjusting the diameter of the support ring comprises inserting a portion of the first end into one of the plurality of recesses.

15. The seal assembly manufactured by the method according to claim 14.

16. The seal assembly manufactured by the method according to claim 13.
